(19) United States
(12) Patent Application Publication
(10) Pub. No.: US 2022/0187655 A1
(43) Pub. Date: Jun. 16, 2022

(54) DISPLAY PANEL GROUNDING

(71) Applicant: Facebook Technologies, LLC, Menlo Park, CA (US)

(72) Inventors: Kyung Won Park, Bellevue, WA (US); Linghui Rao, Bothell, WA (US); Tricia Ann Nensewitz-Zhao, Campbell, CA (US)

(21) Appl. No.: 17/513,729

(22) Filed: Oct. 28, 2021

Related U.S. Application Data
(60) Provisional application No. 63/124,584, filed on Dec. 11, 2020.

(51) Int. Cl. G02F 1/1335; G02B 27/01

(52) U.S. Cl. CPC G02F 1/133528; G09G 3/3648; G02B 27/0172; G02F 1/133514

(57) ABSTRACT

A display device improves the grounding connection of a polarizer by using a metal bridge that couples the polarizer to a ground of the display device. The display device includes a backlight unit (BLU) for providing light for displaying an image, a plurality of pixels for modulating the light provided by the BLU, a polarizer for filtering the light provided by the BLU, and the metal bridge. The metal bridge is disposed in a non-display area surrounding a display area of the display device.

### CROSS REFERENCE TO RELATED APPLICATIONS

This application claims the benefit of U.S. Provisional Application No. 63/124,584, filed Dec. 11, 2020, which is incorporated by reference in its entirety.

### FIELD OF THE INVENTION

This disclosure relates generally to display devices, and more specifically to improving the grounding of a polarizer in liquid crystal displays.

### BACKGROUND

Proper grounding of electronic components provides multiple advantages, such as, protecting the electronic components and the users from electrostatic discharge (ESD). Grounding of the electronic components reduce the amount of charge or static electricity. Static electricity can be accumulated in dielectric or insulating material, such as polymers or plastics. This problem is particularly important in body worn electronics, such as head-mounted displays (HMD) where the buildup of charge may discharge upon contact between the user's body and body worn electronic, causing discomfort.

### SUMMARY

A display device improves the grounding connection of a polarizer using a metal bridge for coupling the polarizer to a ground. The display device includes a backlight unit (BLU) for providing light for displaying an image, a plurality of pixels for modulating the light provided by the BLU, a polarizer for filtering the light provided by the BLU, and the metal bridge for coupling the polarizer to the ground of the display device. The metal bridge is disposed in a non-display area surrounding a display area of the display device.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 1C is a cross section of the front rigid body of the head-mounted display shown in FIG. 1B.

FIG. 2A illustrates a block diagram of an electronic display environment, in accordance with one or more embodiments.

FIG. 2B illustrates a perspective diagram of the elements of the display device, in accordance with one or more embodiments.

FIG. 2C illustrates an example display device with a two-dimensional array of illumination elements or LC-based pixels, in accordance with one or more embodiments.

FIG. 3A illustrates a perspective view of the color filter and the front polarizer, in accordance with one or more embodiments.

FIG. 3B illustrates a perspective view of the color filter and the front polarizer with improved ground connection, in accordance with one or more embodiments.

FIG. 3C illustrates a perspective view of the color filter, in accordance with one or more embodiments.

FIG. 4 illustrates a front view of the color filter and polarizer stack, in accordance with one or more embodiments.

FIG. 5A illustrates a side view of the color filter and polarizer stack along the A-A′ cross-section shown in FIG. 4, in accordance with one or more embodiments.

FIG. 5B illustrates a side view of the color filter and polarizer stack along the B-B′ cross-section shown in FIG. 4, in accordance with one or more embodiments.

FIG. 5C illustrates a side view of the color filter and polarizer stack along the C-C′ cross-section shown in FIG. 4, in accordance with one or more embodiments.

FIG. 5D illustrates a side view of the color filter and polarizer stack along the D-D′ cross-section shown in FIG. 4, in accordance with one or more embodiments.

FIG. 6A illustrates a first example design of a metal bridge disposed on a color filter, according to one or more embodiments.

FIG. 6B illustrates a second example design of a metal bridge disposed on a color filter, according to one or more embodiments.

FIG. 6C illustrates a third example design of a metal bridge disposed on a color filter, according to one or more embodiments.

FIG. 7 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

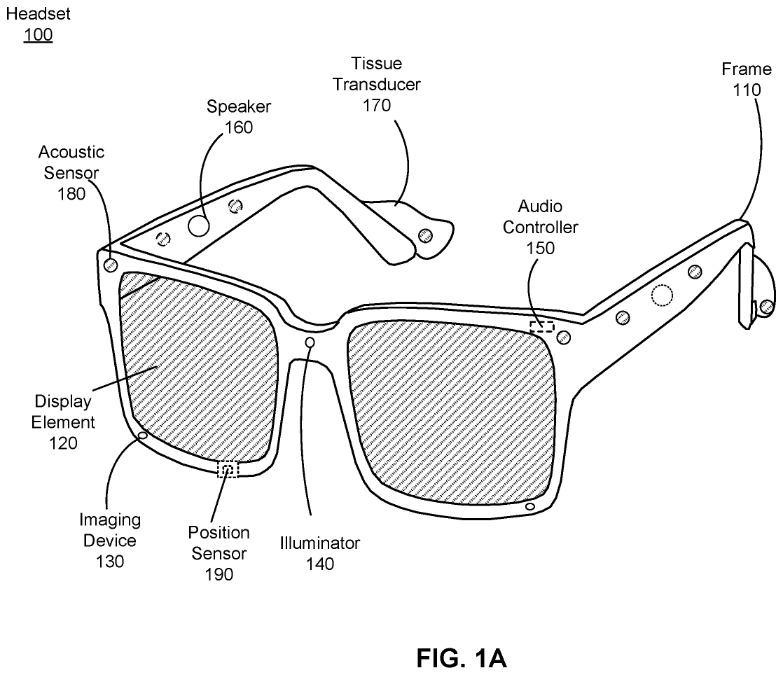

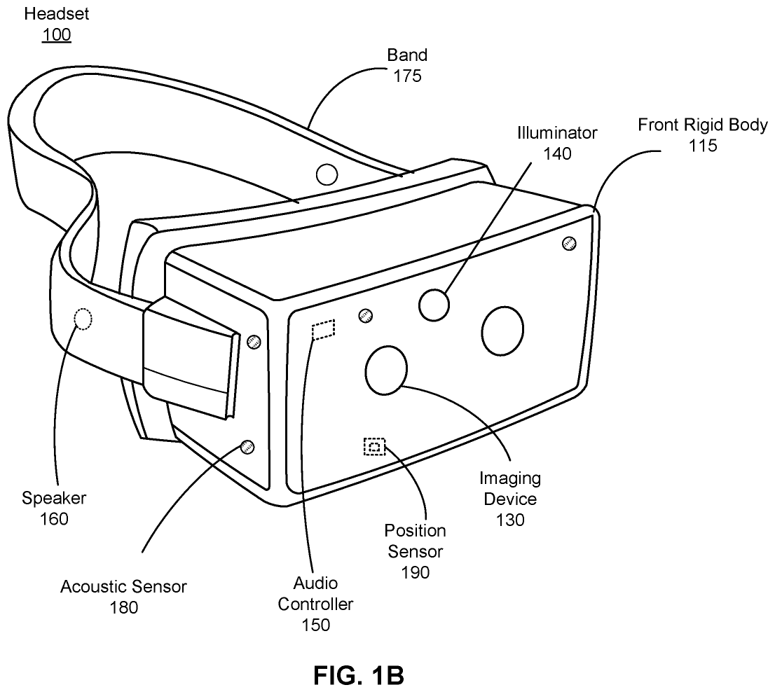

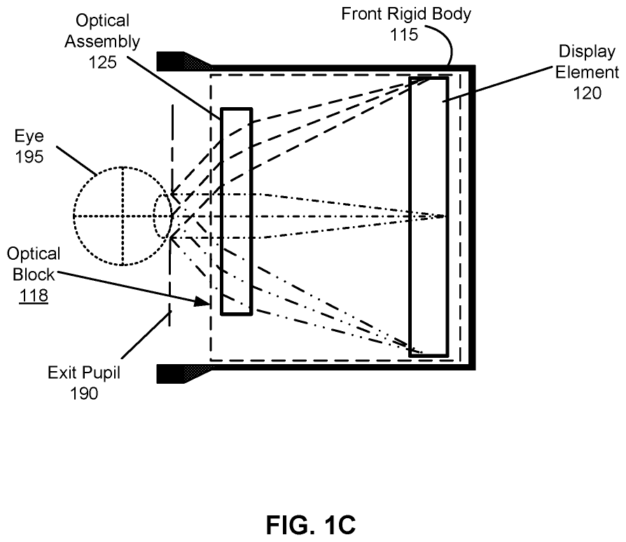

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, earpiece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The DCA may include an eye tracking unit that determines eye tracking information. The eye tracking information may comprise information about a position and an orientation of one or both eyes (within their respective eye-boxes). The eye tracking unit may include one or more cameras. The eye tracking unit estimates an angular orientation of one or both eyes based on images captures of one or both eyes by the one or more cameras. In some embodiments, the eye tracking unit may also include one or more illuminators that illuminate one or both eyes with an illumination pattern (e.g., structured light, glints, etc.). The eye tracking unit may use the illumination pattern in the captured images to determine the eye tracking information. The headset 100 may prompt the user to opt in to allow operation of the eye tracking unit. For example, by opting in the headset 100 may detect, store, images of the user's any or eye tracking information of the user.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

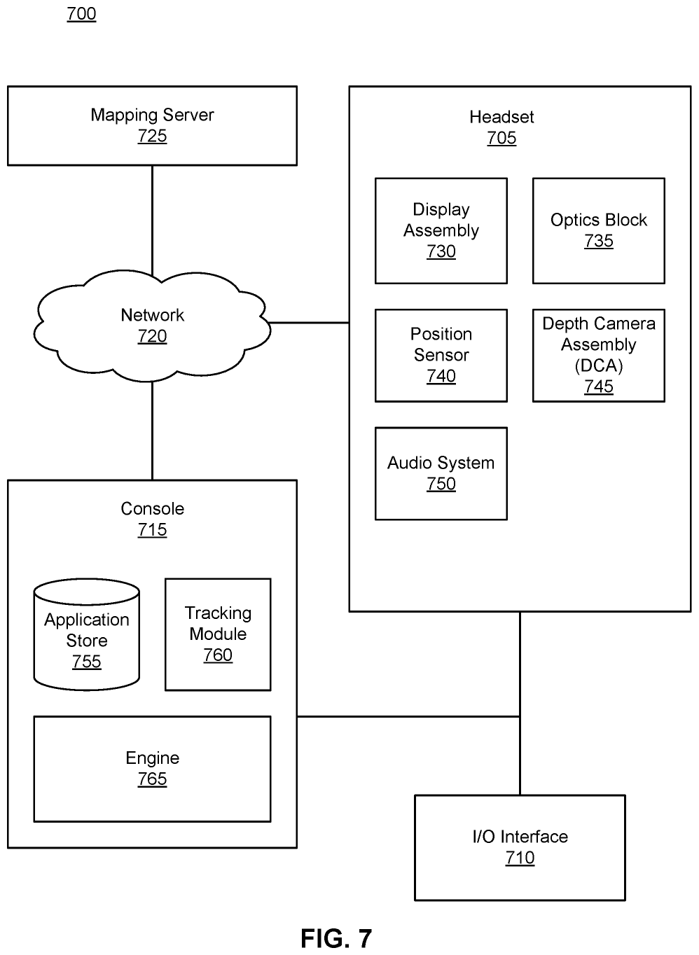

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 7.

FIG. 1B is a perspective view of a headset 105 implemented as an HMD, in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A, but modified to integrate with the HMD form factor. For example, the HMD includes a display assembly, a DCA, an audio system, and a position sensor 190. FIG. 1B shows the illuminator 140, a plurality of the speakers 160, a plurality of the imaging devices 130, a plurality of acoustic sensors 180, and the position sensor 190. The speakers 160 may be located in various locations, such as coupled to the band 175 (as shown), coupled to front rigid body 115, or may be configured to be inserted within the ear canal of a user.

FIG. 1C is a cross section of the front rigid body 115 of the head-mounted display shown in FIG. 1B. As shown in FIG. 1C, the front rigid body 115 includes an optical block 118 that provides altered image light to an exit pupil 190. The exit pupil 190 is the location of the front rigid body 115 where a user's eye 195 is positioned. For purposes of illustration, FIG. 1C shows a cross section associated with a single eye 195, but another optical block, separate from the optical block 118, provides altered image light to another eye of the user.

The optical block 118 includes a display element 120, and the optics block 125. The display element 120 emits image light toward the optics block 125. The optics block 125 magnifies the image light, and in some embodiments, also corrects for one or more additional optical errors (e.g., distortion, astigmatism, etc.). The optics block 125 directs the image light to the exit pupil 190 for presentation to the user.

### System Architecture

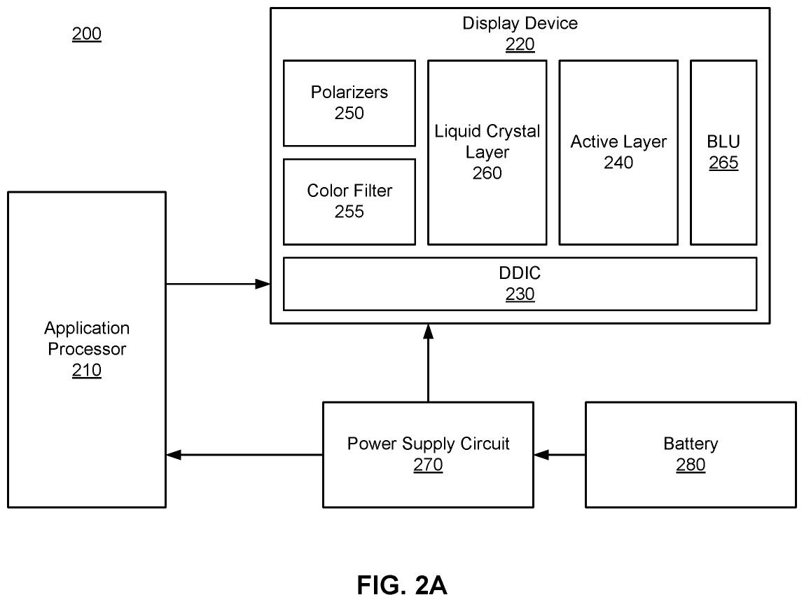

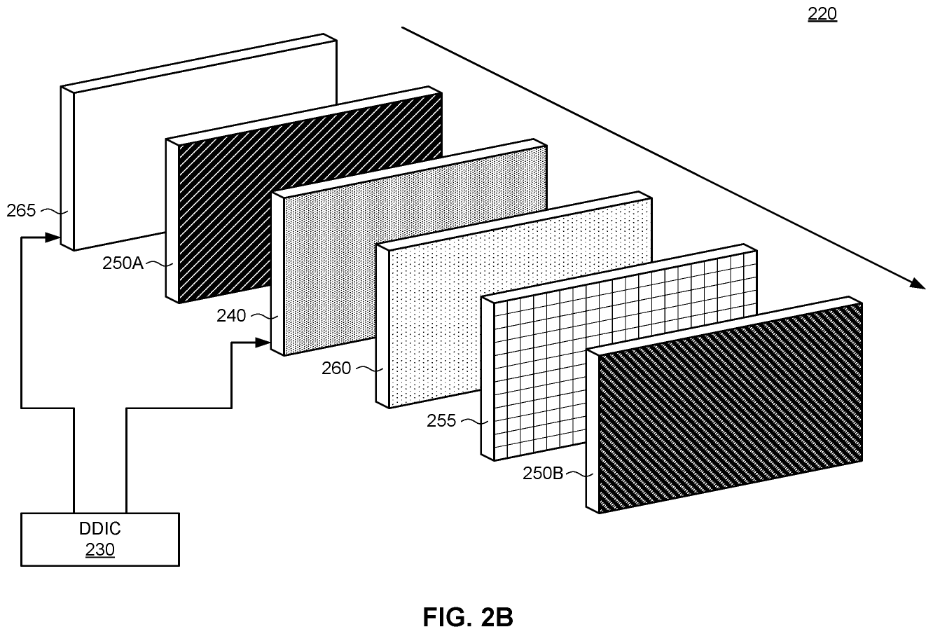

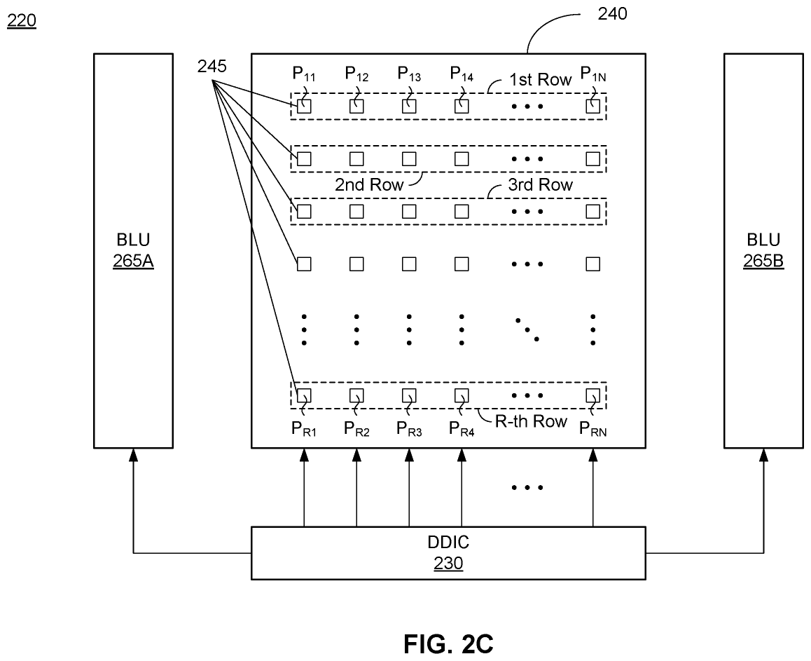

FIG. 2A illustrates a block diagram of an electronic display environment 200, in accordance with one or more embodiments. The electronic display environment 200 includes an application processor 210, and a display device 220. In some embodiments, the electronic display environment 200 additionally includes a power supply circuit 270 for providing electrical power to the application processor 210 and the display device 220. In some embodiments, the power supply circuit 270 receives electrical power from a battery 280. In other embodiments, the power supply circuit 270 receives power from an electrical outlet.

The application processor 210 generates display data for controlling the display device to display a desired image. The display data include multiple pixel data, each for controlling one pixel of the display device to emit light with a corresponding intensity. In some embodiments, each pixel data includes sub-pixel data corresponding to different colors (e.g., red, green, and blue). Moreover, in some embodiments, the application processor 210 generates display data for multiple display frames to display a video.

The display device 220 includes a display driver integrated circuit (DDIC) 230, an active layer 240, a liquid crystal (LC) layer 260, a backlight unit (BLU) 265, polarizers 250, and a color filter 255. The display device 220 may include additional elements, such as one or more additional sensors. The display device 220 may be part of the HMD 100 in FIG. 1A or FIG. 1B. That is, the display device 220 may be an embodiment of the display element 120 in FIG. 1A or FIG. 1C. FIG. 2B illustrates a perspective diagram of the elements of the display device 220, in accordance with one or more embodiments.

The DDIC 230 receives a display signal from the application processor 210, and generates control signals for controlling each pixel 245 in the active layer 240, and the BLU 265. For example, the DDIC 230 generates signals to program each of the pixels 245 in the active layer 240 according to an image signal received from the application processor 210. Moreover, the DDIC 230 generates one or more signals to turn the BLU 265.

The active layer 240 includes a set of pixels 245 organized in rows and columns. For example, the active layer 240 includes N pixels (P₁₁ through P_{1N}) in the first row, N pixels (P₂₁ through P_{2N}) in the second row, N pixels (P₃₁ through P_{3N}) in the third row, and so on. Each pixel includes sub-pixels, each corresponding to a different color. For example, each pixel includes red, green, and blue sub-pixels. In addition, each pixel may include white sub-pixels. Each sub-pixel includes a thin-film-transistor (TFT) for controlling the liquid crystal in the LC layer 260. For example, the TFT of each sub-pixel is used to control an electric field within a specific area of the LC layer to control the crystal orientation of the liquid crystal within the specific area if the LC layer 260.

The LC layer 260 includes a liquid crystal which has some properties between liquids and solid crystals. In particular, the liquid crystal has molecules that may be oriented in a crystal-like way. The crystal orientation of the molecules of the liquid crystal can be controlled or changed by applying an electric field across the liquid crystal. The liquid crystal may be controlled in different way by applying the electric field in different configurations. Schemes for controlling the liquid crystal includes twisted noematic (TN), in-plane switching (IPS), plane line switching (PLS), fringe field switching (FFS), vertical alignment (VA), etc.

Each pixel 245 is controlled to provide a light output that corresponds to the display signal received from the application processor 210. For instance, in the case of an LCD panel, the active layer 240 includes an array of liquid crystal cells with a controllable polarizations state that can be modified to control an amount of light that can pass through the cell.

The BLU 265 includes light sources that are turned on at predetermined time periods to generate light that can pass through each of the liquid crystal cell to produce a picture for display by the display device. The light sources of the BLU 265 illuminate light towards the array of liquid crystal cells in the active layer 240 and the array of liquid crystal cells controls an amount and location of light passing through the active layer 240. In some embodiments, the BLU 265 includes multiple segmented backlight units, each segmented backlight unit providing light sources for a specific region or zone of the active layer 240.

The polarizers 250 filter the light outputted by the BLU 265 based on the polarization of the light. The polarizers 250 may include a back polarizer 250A and a front polarizer 250B. The back polarizer 250A filters the light outputted by the BLU 265 to provide a polarized light to the LC layer 260. The front polarizer 250B filters the light outputted by the LC layer 260. Since the light provided to the LC layer 260 is polarized by the back polarizer 250A, the LC layer controls an amount of filtering of the front polarizer 250B by adjusting the polarization of the light outputted by the back polarizer 250A.

The color filter 255 filters the light outputted by the LC layer 260 based on color. For instance, the BLU 265 generates white light and the color filter 255 filters the white light to output either red, green, or blue light. The color filter 255 may include a grid of red color filters, green color filters, and blue color filters. In some embodiments, the elements of the display device 220 are arranged in a different order. For example, the color filter may be placed between the BLU 265 and the back polarizer 250A, between the back polarizer 250A and the LC layer 260, or after the front polarizer 250B.

FIG. 2C illustrates an example display device 220 with a two-dimensional array of illumination elements or LC-based pixels 245, in accordance with one or more embodiments. In one embodiment, the display device 220 may display a plurality of frames of video content based on a global illumination where all the pixels 245 simultaneously illuminate image light for each frame. In an alternate embodiment, the display device 220 may display video content based on a segmented illumination where all pixels 245 in each segment of the display device 220 simultaneously illuminate image light for each frame of the video content. For example, each segment of the display device 220 may include at least one row of pixels 245 in the display device 220, as shown in FIG. 2C. In the illustrative case where each segment of the display device 220 for illumination includes one row of pixels 245, the segmented illumination can be referred to as a rolling illumination. For the rolling illumination, all pixels 245 in a first row of the display device 220 simultaneously illuminate image light in a first time instant; all pixels 245 in a second row of the display device 220 simultaneously illuminate image light in a second time instant consecutive to the first time instant; all pixels 245 in a third row of the display device 220 simultaneously illuminate image light in a third time instant consecutive to the second time instant, and so on. Other orders of illumination of rows and segments of the display device 220 are also supported in the present disclosure. In yet another embodiment, the display device 220 may display video content based on a controllable illumination where all pixels 245 in a portion of the display device 220 of a controllable size (not shown in FIG. 2C) simultaneously illuminate image light for each frame of the video content. The controllable portion of the display device 220 can be rectangular, square or of some other suitable shape. In some embodiments, a size of the controllable portion of the display device 220 can be a dynamic function of a frame number.

### Display Panel Grounding

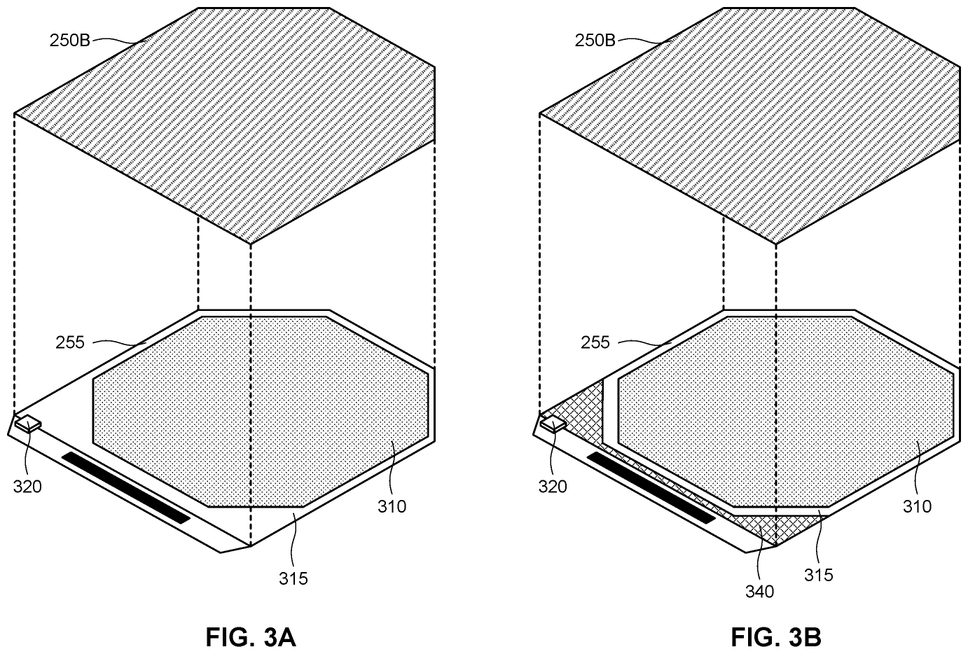

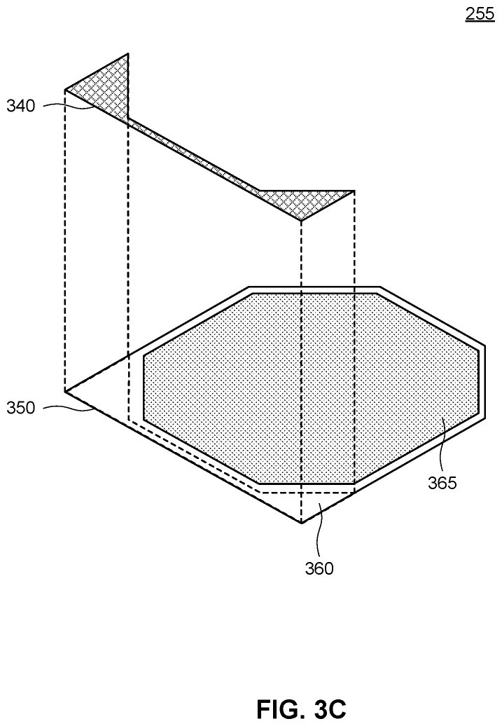

FIG. 3A illustrates a perspective view of the color filter 255 and the front polarizer 250B, in accordance with one or more embodiments. The display device 220 has a display area 310 and a non-display area 315 surrounding the display area 310. The display area 310 corresponds to a portion of the display device 220 that allows portion of the light generated by the BLU 265 to exit, displaying an image. The non-display area 310 surrounds the display area and corresponds to a portion of the display device 220 that blocks the light generated by the BLU 265 from exiting.

The front polarizer 250B is disposed over the color filter 255. The color filter 255 may be made using a glass substrate and the polarizer 250B may be made of a polymer material. The polarizer 250B may be attached to the color filter 255 using an optically clear adhesive (OCA). In order to protect the polarizer 250B (e.g., from electrostatic discharge), the polarizer 250 is connected to ground. In particular, the polarizer 250B is connected to ground through connector 320. In some embodiments, the connector 320 is formed using a conductive paste (such as a silver conductive paste). For instance, the connector 320 may be formed as a silver dot (Ag dot) using a silver conductive paste and curing the paste to form a conductive dot. Moreover, in some embodiments, the OCA used to attach the polarizer 250B to the color filter 255 is designed to be conductive or have a low resistivity.

However, over time, the connection between the polarizer 250B and the connector 320 (e.g., the connection between the OCA of the polarizer 250B and the connector 320) may deteriorate. For example, due to a difference in thermal expansion of the polarizer 250B and the connector 320, the connection between the connector 320 and the polarizer 250B can deteriorate. In another example, the silver paste used for fabricating the connector 320 may degrade over time, leading to a reduction in conductance after exposure to high temperature or high humidity environments. In yet another example, the silver paste used for fabricating the connector 320 may interact with the OCA used for attaching the polarizer 250B to the color filter 255. This reaction can cause delamination of the polarizer 250B causing damage to the display device 220.

To improve the connectivity of the polarizer 250B and the connector 320, a layer of indium-tin-oxide (ITO) may be deposited over the color filter 355. ITO is a transparent material with a relatively high electrical conductivity. However, the ITO layer can degrade the optical performance of the display device 220. For example, the ITO layer may increase the reflectivity of the display panel, or may refract some of the light being emitted by the display panel. Since the ITO layer is disposed over the display area 310, as well as over the non-display area 315 of the display device, the ITO layer may degrade the image quality of the display device.

FIG. 3B illustrates a perspective view of the color filter 255 and the front polarizer 250B with improved ground connection, in accordance with one or more embodiments. In the embodiment of FIG. 3B, the color filter 255 includes a metal bridge 340. The metal bridge 340 is disposed over a non-display area 315, outside of the display area 310.

The metal bridge 340 may be made of any conductive material. Since the metal bridge is disposed outside of the display area 310, the metal bridge 340 does not have to be transparent. As such, non-transparent conductive materials, such as copper, aluminum, or other metals may be used for fabricating the metal bridge 340. Moreover, since the metal bridge 340 improves the connection between the polarizer 250B and the connector 320, the ITO layer may be removed, improving the image quality of the display device.

FIG. 3C illustrates a perspective view of the color filter 255, in accordance with one or more embodiments. The color filter 255 includes a color filter glass 350 and the metal bridge 340. The color filter glass has a display area 365 overlapping with the display area 310 of the display panel 220, and a non-display area 360 surrounding the display area 365. The metal bridge 340 is disposed on the non-display area 315 of the color filter glass 350. In particular, the metal bridge 340 is designed such that is disposed outside of the display area 310 of the color filter glass 350. That is, the metal bridge 340 does not overlap with the display area 310 of the color filter glass 350. As such, the metal bridge 340 does not interfere with the optical properties of the color filter glass within the display area 310.

In some embodiments, the metal bridge 340 is laminated on top of the color filter glass 350. In other embodiments, the metal bridge 340 is deposited on top of the color filter glass 350. In addition, the metal bridge 340 may be patterned before being applied to the color filter glass 350. Alternatively, the metal bridge 340 may be patterned (e.g., etched) after a thin metal layer had been deposited on top of the color filter glass 350 to expose the display area of the color filter.

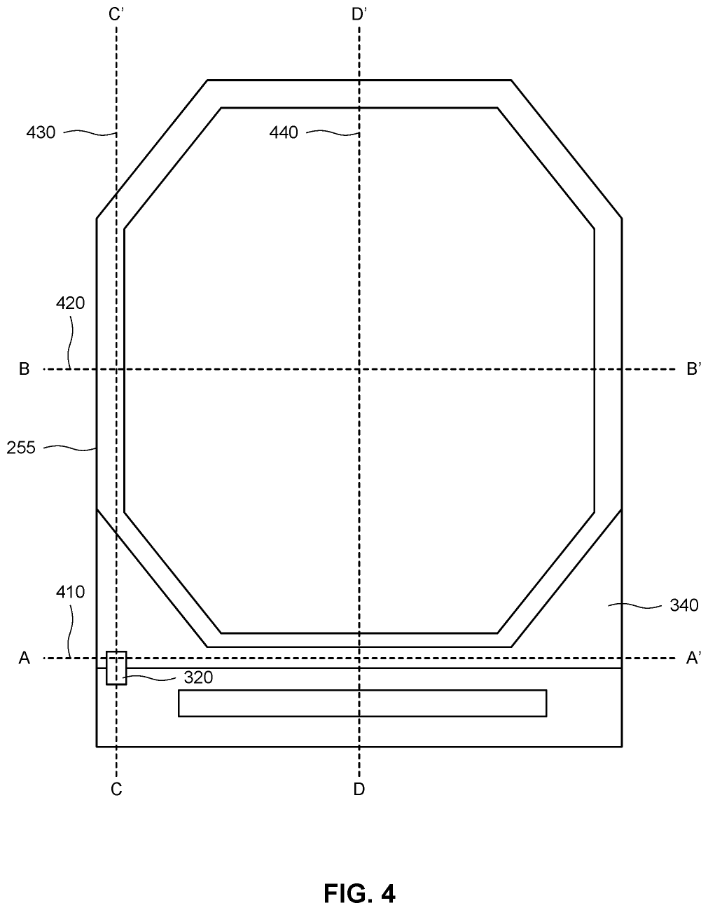

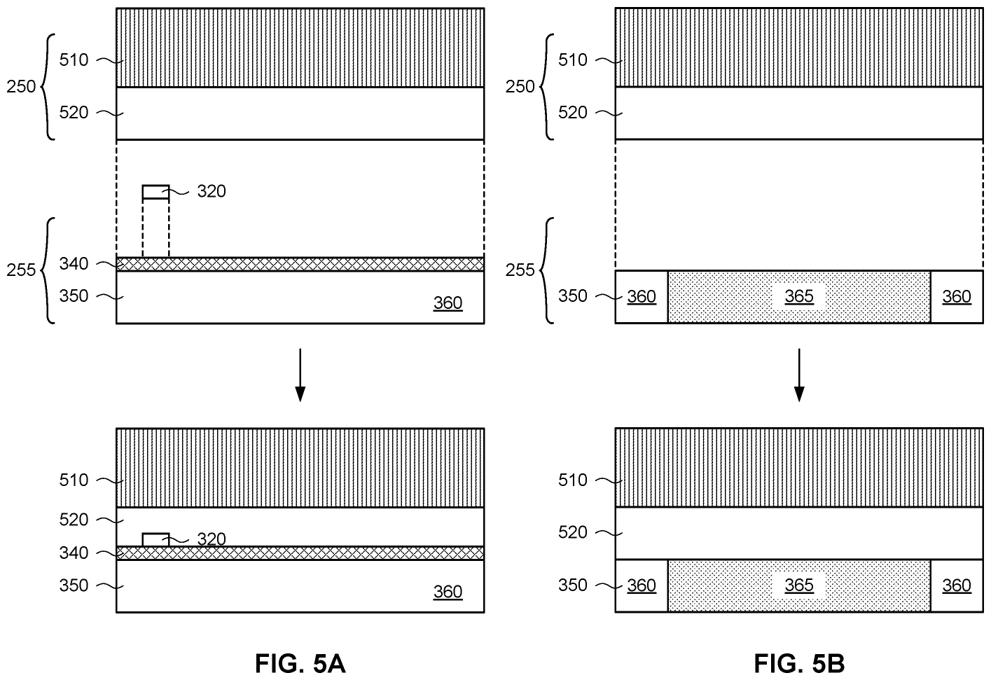

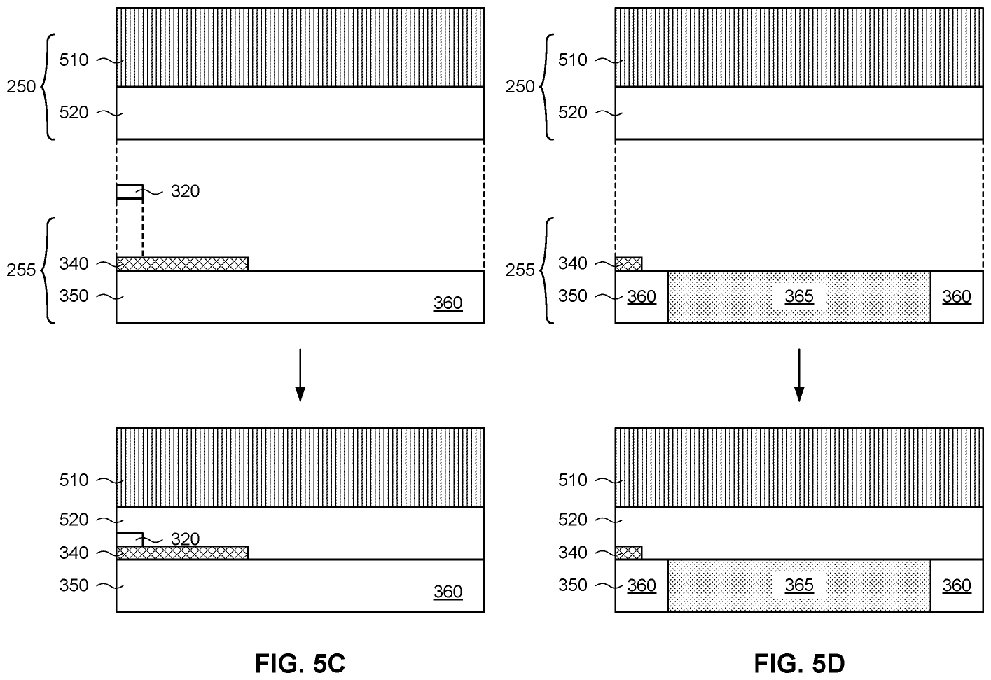

FIG. 4 illustrates a front view of the color filter and polarizer stack, in accordance with one or more embodiments. FIG. 5A illustrates a side view of the color filter and polarizer stack along the A-A′ cross-section shown in FIG. 4, in accordance with one or more embodiments. FIG. 5B illustrates a side view of the color filter and polarizer stack along the B-B′ cross-section shown in FIG. 4, in accordance with one or more embodiments. FIG. 5C illustrates a side view of the color filter and polarizer stack along the C-C′ cross-section shown in FIG. 4, in accordance with one or more embodiments. FIG. 5D illustrates a side view of the color filter and polarizer stack along the D-D′ cross-section shown in FIG. 4, in accordance with one or more embodiments.

The polarizer 250 includes a polarization layer 510 and an OCA layer 520. The color filter 250 includes a color filter glass 350, a metal bridge 340, and a connector 320. The connector 320 electrically connects the metal bridge 340 to a ground of an external board or circuitry (not shown). The OCA is an adhesive layer that attaches the polarizer 250 to the color filter 255 upon contact with the color filter 255. Moreover, when the polarizer 250 is attached to the color filter 250, portions of the OCA layer are caused to make contact with the metal bridge 340. As such, when the polarizer 250 is attached to the color filter 255, the OCA layer is electrically connected to the metal bridge 340. Since the metal bridge 340 is electrically connected to ground (via the connector 320), the OCA is also electrically coupled to ground (via the connector 320 and the metal bridge 340). Moreover, since the metal bridge 340 is over the non-display area 360 of the color filter glass 350, the metal bridge does not affect the optical properties of the color filter glass 350.

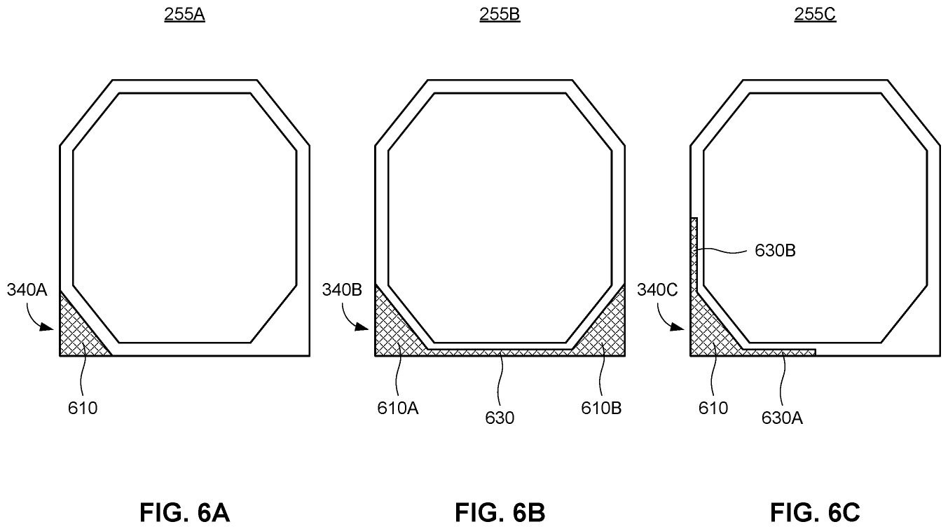

FIG. 6A illustrates a first example design of a metal bridge 340 disposed on a color filter 255A, according to one or more embodiments. The design shown in FIG. 6A has one triangular section 610. The triangular section 610 is located at a corner of the color filter 255A. The location of the triangular section 610 may be chosen based on a location of the connector 320 or a ground connection of an external board or circuitry.

FIG. 6B illustrates a second example design of a metal bridge 340B disposed on a color filter 255B, according to one or more embodiments. The design shown in FIG. 6B has two triangular sections 610 connected to each other by a strip 630. The first triangular section 610A is disposed on a first quadrant of the non-display area 315 and the second triangular section 610B is disposed on a second quadrant of the non-display area 315. In the design of FIG. 6B, either one or both triangular sections may be connected to ground of an external board or circuitry through one or more connectors 320. The design of FIG. 6B increases the area of the metal bridge 340, thereby increase the amount of area for the polarizer 250 to attach to the metal bridge 340.

FIG. 6C illustrates a third example design of a metal bridge 340C disposed on a color filter 255B, according to one or more embodiments. The design shown in FIG. 6C includes a triangular section 610 coupled to two strips 630. The first strip 630A is elongated in a first direction (e.g., across the width of the display device) and the second strip 630B is elongated in a second direction (e.g., across the height of the display device).

In some embodiments, other geometries may be used. For example, a right triangle having a curved hypotenuse may be used instead of the geometry shown in FIGS. 6A through 6C. In some embodiments, the triangle has a concave hypotenuse.

In some embodiments, the metal bridge is used in display having a non-rectangular display area. For example, the display area may have a hexagonal, octagonal, or circular display area. This type of display devices may be used in head-mounted displays used in augmented reality (AR) or virtual reality (VR) applications. In some embodiments, the geometry of the metal bridge is designed based on the geometry of the display area to increase the area of the metal bridge.

### System Environment

FIG. 7 is a system 700 that includes a headset 705, in accordance with one or more embodiments. In some embodiments, the headset 705 may be the headset 100 of FIG. 1A or the headset 105 of FIG. 1B. The system 700 may operate in an artificial reality environment (e.g., a virtual reality environment, an augmented reality environment, a mixed reality environment, or some combination thereof). The system 700 shown by FIG. 7 includes the headset 705, an input/output (I/O) interface 710 that is coupled to a console 715, the network 720, and the mapping server 725. While FIG. 7 shows an example system 700 including one headset 705 and one I/O interface 710, in other embodiments any number of these components may be included in the system 700. For example, there may be multiple headsets each having an associated I/O interface 710, with each headset and I/O interface 710 communicating with the console 715. In alternative configurations, different and/or additional components may be included in the system 700. Additionally, functionality described in conjunction with one or more of the components shown in FIG. 7 may be distributed among the components in a different manner than described in conjunction with FIG. 7 in some embodiments. For example, some or all of the functionality of the console 715 may be provided by the headset 705.

The headset 705 includes the display assembly 730, an optics block 735, one or more position sensors 740, and the DCA 745. Some embodiments of headset 705 have different components than those described in conjunction with FIG. 7. Additionally, the functionality provided by various components described in conjunction with FIG. 7 may be differently distributed among the components of the headset 705 in other embodiments, or be captured in separate assemblies remote from the headset 705.

The display assembly 730 displays content to the user in accordance with data received from the console 715. The display assembly 730 displays the content using one or more display elements (e.g., the display elements 120). A display element may be, e.g., an electronic display. In various embodiments, the display assembly 730 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 735.

The optics block 735 may magnify image light received from the electronic display, corrects optical errors associated with the image light, and presents the corrected image light to one or both eyeboxes of the headset 705. In various embodiments, the optics block 735 includes one or more optical elements. Example optical elements included in the optics block 735 include: an aperture, a Fresnel lens, a convex lens, a concave lens, a filter, a reflecting surface, or any other suitable optical element that affects image light. Moreover, the optics block 735 may include combinations of different optical elements. In some embodiments, one or more of the optical elements in the optics block 735 may have one or more coatings, such as partially reflective or anti-reflective coatings.

Magnification and focusing of the image light by the optics block 735 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 735 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 735 corrects the distortion when it receives image light from the electronic display generated based on the content.

The position sensor 740 is an electronic device that generates data indicating a position of the headset 705. The position sensor 740 generates one or more measurement signals in response to motion of the headset 705. The position sensor 190 is an embodiment of the position sensor 740. Examples of a position sensor 740 include: one or more IMUs, one or more accelerometers, one or more gyroscopes, one or more magnetometers, another suitable type of sensor that detects motion, or some combination thereof. The position sensor 740 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 705 from the sampled data. For example, the IMU integrates the measurement signals received from the accelerometers over time to estimate a velocity vector and integrates the velocity vector over time to determine an estimated position of a reference point on the headset 705. The reference point is a point that may be used to describe the position of the headset 705. While the reference point may generally be defined as a point in space, however, in practice the reference point is defined as a point within the headset 705.

The DCA 745 generates depth information for a portion of the local area. The DCA includes one or more imaging devices and a DCA controller. The DCA 745 may also include an illuminator. Operation and structure of the DCA 745 is described above with regard to FIG. 1A.

The audio system 750 provides audio content to a user of the headset 705. The audio system 750 is substantially the same as the audio system 200 describe above. The audio system 750 may comprise one or acoustic sensors, one or more transducers, and an audio controller. The audio system 750 may provide spatialized audio content to the user. In some embodiments, the audio system 750 may request acoustic parameters from the mapping server 725 over the network 720. The acoustic parameters describe one or more acoustic properties (e.g., room impulse response, a reverberation time, a reverberation level, etc.) of the local area. The audio system 750 may provide information describing at least a portion of the local area from e.g., the DCA 745 and/or location information for the headset 705 from the position sensor 740. The audio system 750 may generate one or more sound filters using one or more of the acoustic parameters received from the mapping server 725, and use the sound filters to provide audio content to the user.

The I/O interface 710 is a device that allows a user to send action requests and receive responses from the console 715. An action request is a request to perform a particular action. For example, an action request may be an instruction to start or end capture of image or video data, or an instruction to perform a particular action within an application. The I/O interface 710 may include one or more input devices. Example input devices include: a keyboard, a mouse, a game controller, or any other suitable device for receiving action requests and communicating the action requests to the console 715. An action request received by the I/O interface 710 is communicated to the console 715, which performs an action corresponding to the action request. In some embodiments, the I/O interface 710 includes an IMU that captures calibration data indicating an estimated position of the I/O interface 710 relative to an initial position of the I/O interface 710. In some embodiments, the I/O interface 710 may provide haptic feedback to the user in accordance with instructions received from the console 715. For example, haptic feedback is provided when an action request is received, or the console 715 communicates instructions to the I/O interface 710 causing the I/O interface 710 to generate haptic feedback when the console 715 performs an action.

The console 715 provides content to the headset 705 for processing in accordance with information received from one or more of: the DCA 745, the headset 705, and the I/O interface 710. In the example shown in FIG. 7, the console 715 includes an application store 755, a tracking module 760, and an engine 765. Some embodiments of the console 715 have different modules or components than those described in conjunction with FIG. 7. Similarly, the functions further described below may be distributed among components of the console 715 in a different manner than described in conjunction with FIG. 7. In some embodiments, the functionality discussed herein with respect to the console 715 may be implemented in the headset 705, or a remote system.

The application store 755 stores one or more applications for execution by the console 715. An application is a group of instructions, that when executed by a processor, generates content for presentation to the user. Content generated by an application may be in response to inputs received from the user via movement of the headset 705 or the I/O interface 710. Examples of applications include: gaming applications, conferencing applications, video playback applications, or other suitable applications.

The tracking module 760 tracks movements of the headset 705 or of the I/O interface 710 using information from the DCA 745, the one or more position sensors 740, or some combination thereof. For example, the tracking module 760 determines a position of a reference point of the headset 705 in a mapping of a local area based on information from the headset 705. The tracking module 760 may also determine positions of an object or virtual object. Additionally, in some embodiments, the tracking module 760 may use portions of data indicating a position of the headset 705 from the position sensor 740 as well as representations of the local area from the DCA 745 to predict a future location of the headset 705. The tracking module 760 provides the estimated or predicted future position of the headset 705 or the I/O interface 710 to the engine 765.

The engine 765 executes applications and receives position information, acceleration information, velocity information, predicted future positions, or some combination thereof, of the headset 705 from the tracking module 760. Based on the received information, the engine 765 determines content to provide to the headset 705 for presentation to the user. For example, if the received information indicates that the user has looked to the left, the engine 765 generates content for the headset 705 that mirrors the user's movement in a virtual local area or in a local area augmenting the local area with additional content. Additionally, the engine 765 performs an action within an application executing on the console 715 in response to an action request received from the I/O interface 710 and provides feedback to the user that the action was performed. The provided feedback may be visual or audible feedback via the headset 705 or haptic feedback via the I/O interface 710.

The network 720 couples the headset 705 and/or the console 715 to the mapping server 725. The network 720 may include any combination of local area and/or wide area networks using both wireless and/or wired communication systems. For example, the network 720 may include the Internet, as well as mobile telephone networks. In one embodiment, the network 720 uses standard communications technologies and/or protocols. Hence, the network 720 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 720 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 720 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 725 may include a database that stores a virtual model describing a plurality of spaces, wherein one location in the virtual model corresponds to a current configuration of a local area of the headset 705. The mapping server 725 receives, from the headset 705 via the network 720, information describing at least a portion of the local area and/or location information for the local area. The user may adjust privacy settings to allow or prevent the headset 705 from transmitting information to the mapping server 725. The mapping server 725 determines, based on the received information and/or location information, a location in the virtual model that is associated with the local area of the headset 705. The mapping server 725 determines (e.g., retrieves) one or more acoustic parameters associated with the local area, based in part on the determined location in the virtual model and any acoustic parameters associated with the determined location. The mapping server 725 may transmit the location of the local area and any values of acoustic parameters associated with the local area to the headset 705.

One or more components of system 700 may contain a privacy module that stores one or more privacy settings for user data elements. The user data elements describe the user or the headset 705. For example, the user data elements may describe a physical characteristic of the user, an action performed by the user, a location of the user of the headset 705, a location of the headset 705, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 700 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

The language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A display device comprising:
a backlight unit (BLU) for providing light for displaying an image;
a plurality of pixels for modulating the light provided by the BLU, the plurality of pixels disposed in a display area of the display device;
a polarizer configured to filter the light provided by the BLU based on the modulation performed by the plurality of pixels; and
a metal bridge coupled to the polarizer, the metal bridge disposed in a non-display area surrounding the display area of the display device, wherein the metal bridge does not overlap with the display area of the display device.

2. The display device of claim 1, further comprising:
a color filter, wherein the metal bridge is disposed between the color filter and the polarizer.

3. The display device of claim 2, wherein a first surface of the metal bridge is adhered to a first portion of the color filter, wherein a second surface of the metal bridge, opposite to the first surface, is adhered to a first portion of the polarizer, and wherein a second portion of the polarizer is adhered to a second portion of the color filter.

4. The display device of claim 1, further comprising:
a connector coupled to the metal bridge, the connector for connecting the metal bridge to a ground of the display device.

5. The display device of claim 4, wherein the connector is a silver (Ag) dot connector.

6. The display device of claim 1, wherein the metal bridge comprises:
a first triangular section corresponding to a first corner of the polarizer.

7. The display device of claim 6, wherein the metal bridge further comprises:
a second triangular section corresponding to a second corner of the polarizer; and
a connecting strip connecting the first triangular section to the second triangular section.

8. The display device of claim 6, wherein the metal bridge further comprises:
a first extension strip extending from a first corner of the first triangle in a first direction; and
a second extension strip extending from a second corner of the first triangle in a second direction, perpendicular to the first direction.

9. The display device of claim 1, further comprising:
an optically clear adhesive (OCA) disposed over the polarizer, the OCA for adhering the polarizer to the metal bridge.

10. The display device of claim 9, wherein the OCA is electrically conductive.

11. The display device of claim 1, wherein the metal bridge if made of a non-transparent material.

12. The display device of claim 1, wherein the metal bridge if patterned so as to not cover the display area of the display device.

13. A color filter for a display device, comprising:
a color filter glass having a display area and a non-display area surrounding the display area; and
a metal bridge disposed on the non-display area of the color filter glass, wherein the metal bridge does not overlap with the display area of the color filter glass.

14. The color filter glass of claim 13, wherein the metal bridge comprises
a first triangular section corresponding to a first corner of the color filter glass.

15. The color filter glass of claim 14, wherein the metal bridge further comprises:
a second triangular section corresponding to a second corner of the color filter glass; and
a connecting strip connecting the first triangular section to the second triangular section.

16. The color filter glass of claim 13, wherein the metal bridge further comprises:
a first extension strip extending from a first corner of the first triangle in a first direction; and
a second extension strip extending from a second corner of the first triangle in a second direction, perpendicular to the first direction.

17. The color filter glass of claim 13, further comprising:
a connector coupled to the metal bridge, the connector for connecting the metal bridge to a ground of the display device.

18. The color filter glass of claim 17, wherein the connector is a silver (Ag) dot connector.

19. The color filter glass of claim 13, wherein the metal bridge if made of a non-transparent material.

20. A head-mounted display comprising:
A display device comprising:
a backlight unit (BLU) for providing light for displaying an image;
a plurality of pixels for modulating the light provided by the BLU, the plurality of pixels disposed in a display area of the display device;
a polarizer configured to filter the light provided by the BLU based on the modulation performed by the plurality of pixels; and
a metal bridge coupled to the polarizer, the metal bridge disposed in a non-display area surrounding the display area of the display device, wherein the metal bridge does not overlap with the display area of the display device.
